(19) United States
(12) Patent Application Publication
(10) Pub. No.: US 2007/0115241 A1
(43) Pub. Date: May 24, 2007

(54) DISPLAY PANEL CONTROL CIRCUIT AND DISPLAY DEVICE

(76) Inventor: Kentaro TERANISHI, Kanazawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/560,693

(22) Filed: Nov. 16, 2006

(30) Foreign Application Priority Data
Nov. 21, 2005 (JP) 2005-335924

(51) Int. Cl. G09G 3/36

(52) U.S. Cl. 345/98

(57) ABSTRACT

A display panel control circuit includes a controller which processes external image data and sync signals from an external signal source, and source and gate drivers which drive a display panel on the basis of processed results from the controller. The controller is configured to provide predetermined internal image data and sync signals which are generated immediately after supply of power and processed instead of the external image data and sync signals, and whose processing results are temporarily output to the source and gate drivers.

### CROSS-REFERENCE TO RELATED APPLICATIONS

This application is based upon and claims the benefit of priority from prior Japanese Patent Application No. 2005-335924, filed Nov. 21, 2005, the entire contents of which are incorporated herein by reference.

### BACKGROUND OF THE INVENTION

1. Field of the Invention

The present invention relates to a display panel control circuit which is applied to a liquid crystal display panel of, e.g., an optically compensated bend (OCB) mode, and a display device including the display panel control circuit.

2. Description of the Related Art

Flat-panel displays realized by liquid crystal display devices are widely used in computers, car navigation systems, TV receivers, and similar equipment.

In general, a liquid crystal display device utilizes a liquid crystal display panel, which includes a matrix of liquid crystal pixels, and a display panel control circuit which controls this display panel. The liquid crystal display panel has a structure wherein a liquid crystal layer is held between an array substrate and a counter-substrate.

The array substrate includes a plurality of pixel electrodes which are arrayed substantially in a matrix, a plurality of gate lines which are arranged along the rows of pixel electrodes, a plurality of source lines which are arranged along the columns of pixel electrodes, and a plurality of switching elements which are disposed near intersections between the gate lines and source lines. Each of the switching elements is composed of, e.g., a thin-film transistor (TFT). The switching element is turned on when one associated gate line is driven, thereby applying a potential of one associated source line to one associated pixel electrode. The counter-substrate includes a common electrode which is opposed to the pixel electrodes disposed on the array substrate. A pair of one pixel electrode and the common electrode, together with a pixel region that is a part of the liquid crystal layer held between these electrodes, constitute a pixel, and control the alignment of liquid crystal molecules in the pixel region by an electric field which is created between the pixel electrode and the common electrode. The display panel control circuit includes a gate driver which drives the gate lines, a source driver which drives the source lines, and a controller which controls the operations of the gate driver and source driver on the basis of external image data and sync signals which are supplied from outside.

In liquid crystal display devices for TV receivers, which principally display moving images, the introduction of a liquid crystal display panel of an OCB mode, in which liquid crystal molecules exhibit good responsivity (see Jpn. Pat. Appln. KOKAI Publication No. 2002-202491), has been studied. Before supply of power, liquid crystal molecules are set in a substantially horizontal splay alignment by alignment layers that are provided on the pixel electrode and common electrode and are rubbed in mutually parallel directions. In this liquid crystal display panel, a display operation is performed after the splay alignment is transitioned to a bend alignment in an initializing process by a relatively intense electric field that is applied upon supply of power.

The reason why the liquid crystal molecules are set in the splay alignment before supply of power is that the splay alignment is more stable than the bend alignment in terms of energy in a voltage-non-applied state of a liquid crystal driving voltage. Even if the liquid crystal molecules once transition to the bend alignment, reverse transition from the bend alignment to the splay alignment tends to occur if a voltage-non-applied state, or a voltage-applied state of a voltage not greater than a level at which energy of the splay alignment is balanced with energy of the bend alignment, continues for a long time. In the splay alignment, abnormality in display may occur since the viewing angle characteristics of the splay alignment are sharply different from those of the bend alignment.

In the prior art, as a measure for preventing the above reverse transition from the bend alignment to the splay alignment, such a driving method is adopted that a high voltage is applied to the OCB liquid crystal pixel, for example, in a part of a frame period within which a single-frame image is displayed. In a normally-white liquid crystal display panel, this voltage corresponds to a pixel voltage for effecting black display, so this driving method is called “black insertion driving”.

Also, immediately after supply of power to the system including the signal source of the above-mentioned image data and sync signal, noise-like image disturbance occurs on the display panel, leading to degradation in the quality of the product.

### BRIEF SUMMARY OF THE INVENTION

An object of the present invention is to provide a display panel control circuit and a display device, which can prevent image disturbance, which occurs immediately after supply of power.

According to the present invention, there is provided a display panel control circuit comprising a processing circuit which processes external image data and sync signals which are supplied from outside, and a driving circuit which drives the display panel on the basis of processing results from the processing circuit, the processing circuit being configured to provide predetermined internal image data and sync signal, which are generated immediately after supply of power and processed instead of the external image data and sync signal, and whose processing results are temporarily output to the driving circuit.

According to the invention, there is provided a display device comprising a display panel and a display panel control circuit which controls a display operation of the display panel, the display panel control circuit including a processing circuit which processes external image data and sync signals which are supplied from outside, and a driving circuit which drives the display panel on the basis of processing results from the processing circuit, the processing circuit being configured to provide predetermined internal image data and sync signals which are generated immediately after supply of power and processed instead of the external image data and sync signal, and whose processing results are temporarily output to the driving circuit.

In these display panel control circuit and display device, the processing circuit provides predetermined internal image data and sync signal, which are generated immediately after supply of power and processed instead of the external image data and sync signals, and whose processing results are temporarily output to the driving circuit. Specifically, the external image data and sync signals are not in the normal state immediately after supply of power. However, the external image data and sync signals are not processed to obtain the processing results to be output to the driving circuit. Therefore, a noise-like image disturbance is prevented from occurring on the display panel.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the circuit structure of a liquid crystal display device according to an embodiment of the present invention;

FIG. 2 is a circuit diagram showing main components that serve as a controller and a source driver shown in FIG. 1;

FIG. 3 is a timing chart illustrating an operation in a case where black insertion driving is executed at a 2X vertical scanning speed in the liquid crystal display device shown in FIG. 1; and

FIG. 4 is a flowchart illustrating a switching process of a timing control unit shown in FIG. 2.

### DETAILED DESCRIPTION OF THE INVENTION

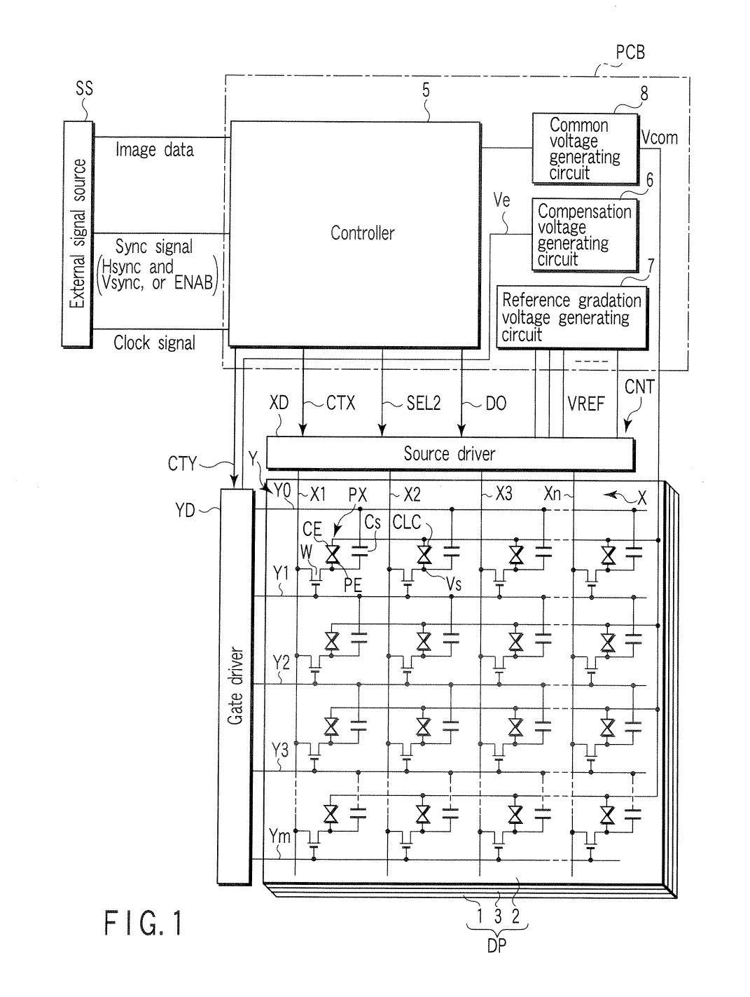

A liquid crystal display device according to an embodiment of the present invention will now be described with reference to the accompanying drawings. FIG. 1 schematically shows the circuit structure of the liquid crystal display device. The liquid crystal display device includes an OCB mode liquid crystal display panel DP, and a display panel control circuit CNT which is connected to the display panel DP. The liquid crystal display panel DP is configured such that a liquid crystal layer 3 is held between an array substrate 1 and a counter-substrate 2, which are a pair of electrode substrates. The liquid crystal layer 3 includes a liquid crystal material in which liquid crystal molecules are aligned in a splay alignment in a voltage-non-applied state. Upon supply of power, the display panel control circuit CNT performs initialization of the liquid crystal display panel DP in order to enable a normally white display operation. In the initialization, a relatively high transition voltage is applied to the liquid crystal layer 3 from the array substrate 1 and counter-substrate 2 as a liquid crystal driving voltage, which causes the liquid crystal molecules to transition from the splay alignment to a bend alignment. In the display operation, the transmittance of the liquid crystal display panel DP is controlled by the liquid crystal driving voltage applied to the liquid crystal layer 3. Further, a black-display voltage is cyclically applied to the liquid crystal layer 3 as the liquid crystal driving voltage in order to prevent reverse transition from the bend alignment to the splay alignment.

The array substrate 1 includes a plurality of pixel electrodes PE which are arrayed substantially in a matrix on a transparent insulating substrate such as a glass substrate; a plurality of gate lines Y (Y0 to Ym) which are arranged along the rows of pixel electrodes PE; a plurality of source lines X (X1 to Xn) which are arranged along the columns of pixel electrodes PE; and a plurality of pixel switching elements W which are arranged near intersections between the gate lines Y and source lines X and made conductive between the associated source lines X and the associated pixel electrodes PE when driven via the associated gate lines Y. Each of the pixel switching elements W is composed of, e.g., a thin-film transistor. The gate of the thin-film transistor is connected to the gate line Y, and the source-drain path of the thin-film transistor is connected between the source line X and the pixel electrode PE.

The counter-substrate 2 includes a color filter which are disposed on a transparent insulating substrate such as a glass substrate, and a common electrode CE which is disposed on the color filter so as to be opposed to the pixel electrodes PE. Each of the pixel electrodes PE and the common electrode CE are formed of transparent electrode material such as ITO, and are covered with alignment films which are subjected to rubbing treatment in mutually parallel directions. Each pixel electrode PE and the common electrode CE, together with a pixel region of the liquid crystal layer 3 in which the alignment of liquid crystal molecules is controlled by an electric field applied from the pixel electrode PE and common electrode CE, constitute a pixel PX.

Each of the pixels PX includes a liquid crystal capacitance CLC between the associated pixel electrode PE and common electrode CE, and is connected to one end of an associated one of storage capacitances Cs. Each storage capacitance Cs is obtained by capacitive coupling between the pixel electrode PE of the associated pixel PX and a preceding-stage gate line Y which neighbors the display pixel PX on one side and controls the pixel switching element W of the display pixel PX. Each storage capacitance Cs has a sufficiently large capacitance, relative to a parasitic capacitance of the pixel switching element W. FIG. 1 omits depiction of a plurality of dummy pixels which are disposed around the matrix array of pixels PX that constitute the display screen. The dummy pixels are wired similarly with the pixels PX within the display screen. The dummy pixels are provided in order to equalize the conditions of all pixels PX within the display screen with respect to, e.g., parasitic capacitances. The gate line Y0 is a gate line for the dummy pixels.

The display panel control circuit CNT includes a gate driver YD which sequentially drives the gate lines Y so as to turn on the switching elements W on a row-by-row basis; a source driver XD which outputs pixel voltages Vs to the source lines X during a time period in which the switching elements W of each row are driven by the associated gate line Y; and a controller 5 which controls the gate driver YD and source driver XD on the basis of image data, sync signals and a clock signal, which are supplied from an external signal source SS. The image data includes a plurality of pixel data items for a gradation image, which are associated with the pixels PX, and are updated in every predetermined cycle of 1 frame period (vertical scanning period). The sync signals are, e.g., a vertical sync signal Vsync and a horizontal sync signal Hsync (or a composite sync signal ENAB in which the vertical and horizontal sync signals Vsync and Hsync are superimposed). The clock signal is a pulse signal with a predetermined frequency, which is output more stably than the image data and sync signals immediately after supply of power. The display panel control circuit CNT further includes a compensation voltage generating circuit 6, a reference gradation voltage generating circuit 7, and a common voltage generating circuit 8. The compensation voltage generating circuit 6 generates a compensation voltage Ve. When the switching elements W of one row are turned off, the compensation voltage Ve is applied via the gate driver YD to a preceding-stage gate line Y, which neighbors, on one side, a gate line Y which is connected to these switching elements W, and the compensation voltage Ve compensates a variation in the pixel voltage Vs, which occurs in the pixels PX of the associated row due to parasitic capacitances of these switching elements W. The reference gradation voltage generating circuit 7 generates a predetermined number of reference gradation voltages VREF that are used in order to convert the image data to the pixel voltages Vs. The common voltage generating circuit 8 generates a common voltage that is applied to the common electrode CE. The liquid crystal driving voltage is a potential difference between the potential of the pixel electrode PE, which is set by the pixel voltage Vs, and the potential of the common electrode CE, which is set by the common voltage Vcom, and the polarity of the liquid crystal driving voltage is reversed so as to execute, for example, a frame-reversal driving scheme and a line-reversal driving scheme. Also, the transition voltage is obtainable by supplying the common electrode CE with the common voltage Vcom that shifts the potential of the common electrode CE, relative to the potential of the pixel electrode PE, to a greater degree than when the normal display operation is performed.

The gate driver YD and source driver XD are integrated circuit (IC) chips which are mounted on flexible wiring sheets that are disposed, for example, along the outer edge of the array substrate 1. In addition, the controller 5, compensation voltage generating circuit 6, reference gradation voltage generating circuit 7 and common voltage generating circuit 8 are disposed on a printed circuit board PCB which is independent from the liquid crystal display panel DP.

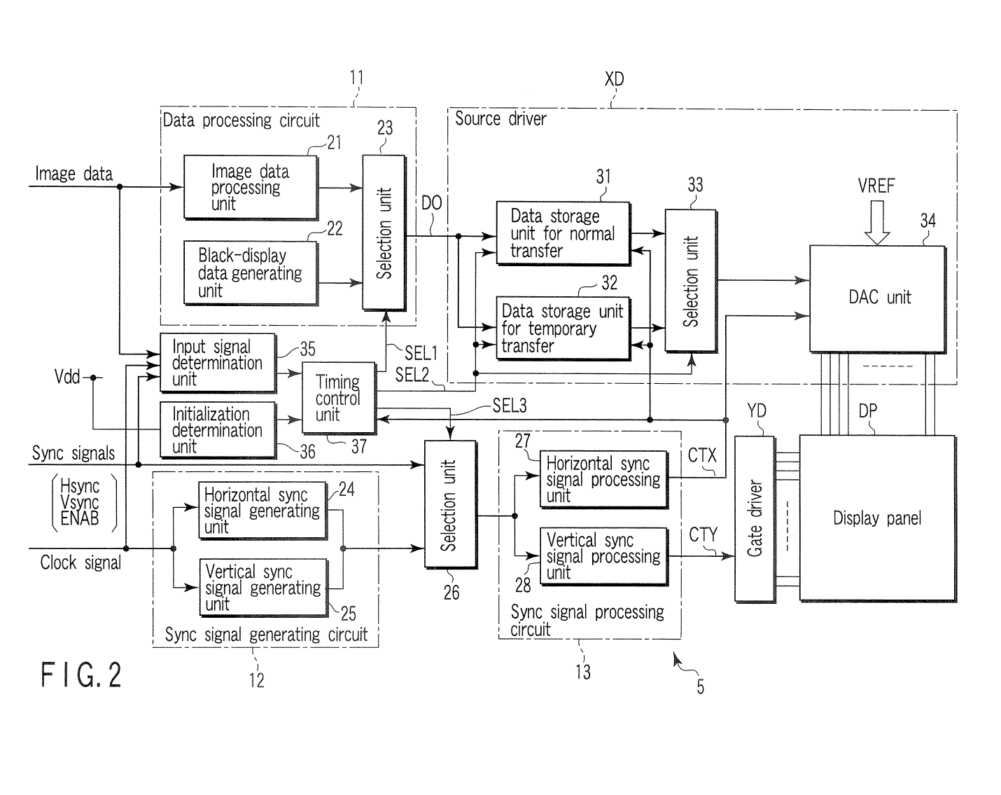

FIG. 2 shows main components that serve as the controller 5 and source driver XD. The controller 5 includes a data processing circuit 11 which processes image data from the external signal source SS; a sync signal generating circuit 12 which internally generates a vertical sync signal Vsync and a horizontal sync signal Hsync; and a sync signal processing circuit 13 which processes the vertical and horizontal sync signals Vsync, Hsync (or composite sync signal ENAB) from the external signal source SS and the vertical and horizontal sync signals Vsync, Hsync from the sync signal generating circuit 12.

The data processing circuit 11 includes an image data processing unit 21, a black-display data generating unit 22 and a selection unit 23. The image data processing unit 21 performs processes of resolution conversion, gamma correction, etc., with respect to items of gradation image pixel data for a single-frame, which are supplied as the image data from the external signal source SS. Thereby, the image data processing unit 21 sequentially outputs n items of gradation image pixel data to each display pixel line (pixels PX of each row). The black-display data generating unit 22 performs a process of internally generating black-display data which is an item of non-gradation image pixel data, and outputs the item of the black-display data to each display pixel line (pixels PX of each line). The selection unit 23 outputs, as output pixel data DO, one of a processing result of the image data processing unit 21 and a processed result of the black-display data generating unit 22. The sync signal generating circuit 12 includes a horizontal sync signal generating unit 24 and a vertical sync signal generating unit 25. The horizontal sync signal generating unit 24 generates a horizontal sync signal Hsync on the basis of a clock signal from the external signal source SS. The vertical sync signal generating unit 25 generates a vertical sync signal Vsync on the basis of a clock signal from the external signal source SS. A pair of the vertical and horizontal sync signals Vsync, Hsync (or composite sync signal ENAB) from the external signal source SS and a pair of the vertical and horizontal sync signals Vsync, Hsync from the sync signal generating circuit 12 are delivered to a selection unit 26. The selection unit 26 is provided in order to output either of the sync signal pairs. The sync signal processing circuit 13 includes a horizontal sync signal processing unit 27 and a vertical sync signal processing unit 28. The horizontal sync signal processing unit 27 processes the horizontal sync signal Hsync (or horizontal sync signal Hsync included in the composite sync signal ENAB) which is output from the selection unit 26, and generates a horizontal scanning timing control signal CTX which is composed of a source start pulse, a source latch pulse and a source polarity pulse. The vertical sync signal processing unit 28 processes the vertical sync signal Vsync (or vertical sync signal Vsync included in the composite sync signal ENAB) which is output from the selection unit 26, and generates a vertical scanning timing control signal CTY which is composed of a gate start pulse and a gate enable pulse.

The source driver XD includes a data storage unit 31 for normal transfer, a data storage unit 32 for temporary transfer, a selection unit 33, and a digital-to-analog converter (DAC) unit 34. The data storage unit 31 for normal transfer stores n items of gradation image pixel data, which are sequentially output from the selection unit 23 as output pixel data DO, in n channels that are assigned to the source lines X1 to Xn, and outputs the n items of gradation image pixel data in parallel. The data storage unit 32 for temporary transfer has n channels which are assigned to the source lines X1 to Xn and each of which commonly stores an item of non-gradation image pixel data (black-display data) which is output from the selection unit 23 as output pixel data DO, and outputs the items of non-gradation image pixel data in parallel. The selection unit 33 outputs either of the n items of gradation image pixel data, which are output from the data storage unit 31 for normal transfer in parallel, and the n items of non-gradation image pixel data, which are output from the data storage unit 32 for temporary transfer in parallel. The DAC unit 34 converts the n items of pixel data, which are output from the selection unit 33, to pixel voltages Vs by using the predetermined number of reference gradation voltages VREF, and outputs the pixel voltages Vs to the source lines X1 to Xn of the liquid crystal display panel DP. In the data storage unit 31 for normal transfer and the data storage unit 32 for temporary transfer, the storage of the pixel data is executed in sync with the source start pulse and the output of the pixel data is executed in sync with the source latch pulse. In the DAC unit 34, the pixel voltages Vs, which are output to the source lines X1 to Xn, are set at a polarity corresponding to the source polarity pulse.

The gate driver YD selects and drives the gate lines Y1 to Ym on a one-by-one basis in order to display a gradation image, and selects and drives the gate lines Y1 to Ym in units of a predetermined number of gate lines in order to display a non-gradation image. The selection for the gradation image display and the selection for the non-gradation image display are performed in sync with the gate start pulse, and the selection result for the gradation image display and the selection result for the non-gradation image display are switched by the control of the gate enable signal. In the case where the black insertion driving is carried out at a 2X horizontal scanning speed, the gate driver YD sequentially selects the gate lines Y1 to Ym for the non-gradation image display (i.e., for black insertion) in every 1 vertical scanning period (1V), and outputs the driving signal to the selected gate line Y so as to turn on the pixel switching elements W of each row in units of an H/2 period, which is half the horizontal scanning period (1H). Further, the gate driver YD sequentially selects the gate lines Y1 to Ym for the gradation image display and outputs the driving signal to the selected gate line Y so as to turn on the pixel switching elements W of each row in units of an H/2 period. In association with this operation, in the source driver XD, the selection unit 33 outputs n items of non-gradation image pixel data B and n items of gradation image pixel data S in parallel in units of the H/2 period in every 1 horizontal scanning period. The DAC unit 34 converts the items of non-gradation image pixel data B and the items of gradation image pixel data S to pixel voltages Vs by referring to the predetermined number of reference gradation voltages VREF which are supplied from the reference gradation voltage generating circuit 7, and outputs the pixel voltages Vs to the source lines X1 to Xn in parallel.

If the gate driver YD drives, for instance, the gate line Y1 by the driving voltage and turns on all the pixel switches W that are connected to the gate line Y1, the pixel voltages Vs on the source lines X1 to Xn are supplied to one end of the associated pixel electrode PE and one end of the associated storage capacitance Cs via each of the pixel switching elements W. In addition, the gate driver YD outputs the compensation voltage Ve from the compensation voltage generating circuit 6 to the preceding-state gate line YO that neighbors the gate line Y1, and turns on all the pixel switching elements W, which are connected to the gate line Y1, only during the H/2 period. Immediately thereafter, the gate driver YD outputs a non-driving voltage, which turns off these switching elements W, to the gate line Y1. When these pixel switching elements W are turned off, the compensation voltage Ve reduces the amount of charge that is to be extracted from the pixel electrodes PE due to the parasitic capacitances of the pixel switching elements W, thereby substantially canceling a variation in pixel voltage Vs, that is, a field-through voltage ΔVp.

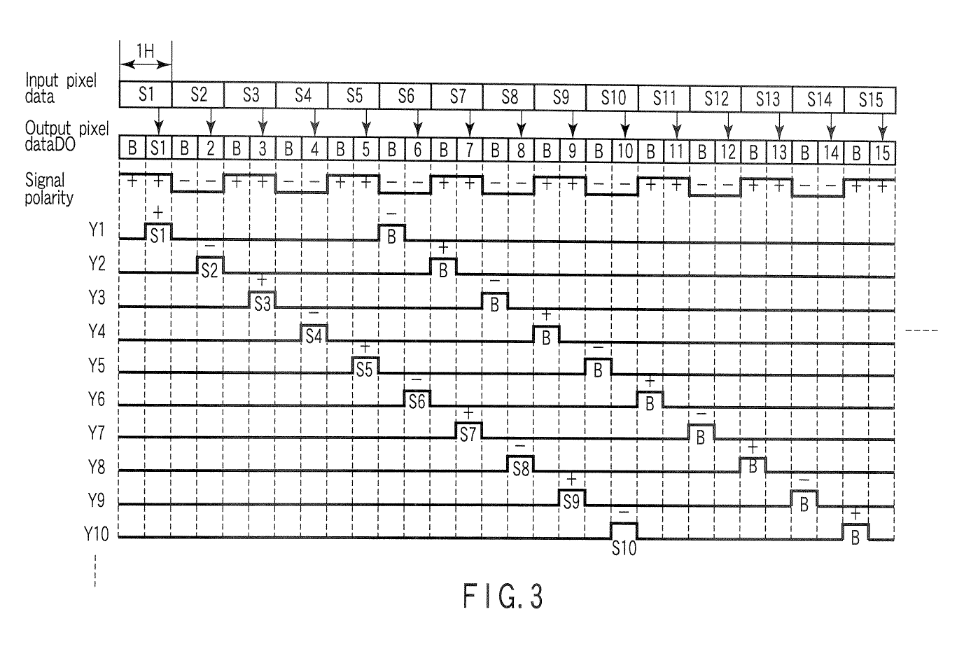

FIG. 3 illustrates an operation in a case where black insertion driving is executed at a 2X vertical scanning speed in this liquid crystal display device. In FIG. 3, B represents the non-gradation image pixel data that is common to the pixels PX of each row, and S1, S2, S3, . . . , represent the gradation image pixel data for the pixels PX of the first row, second row, third row, . . . , respectively. Signs “+” and “−” represent the signal polarities at the time when the pixel data B, S1, S2, S3, . . . , are converted to pixel voltages Vs and output to the source driver XD.

The gate lines Y1 to Ym are sequentially selected for the gradation image in every 1H period in one vertical scanning period, and each of the gate lines Y1 to Ym is driven by a driving signal that is output in a second half of the associated horizontal scanning period H. Each of the gradation image pixel data S1, S2, S3, . . . , is converted to pixel voltages Vs in the second half of the associated horizontal scanning period H, and the pixel voltages Vs are output to the source lines X1 to Xn in parallel. These pixel voltages Vs are supplied to the liquid crystal pixels PX of the first row, second row, third row, . . . , while each of the gate lines Y1 to Ym is driven in the second half of the associated horizontal scanning period H.

In addition, the gate lines Y1 to Ym are sequentially selected for the non-gradation image in every 1 H period in the vertical scanning period, and each of the gate lines Y1 to Ym is driven by a driving signal that is output in a first half of the associated horizontal scanning period H. Each of the non-gradation image pixel data B, B, B, . . . , is converted to pixel voltages Vs in the first half of the associated horizontal scanning period H, and the pixel voltages Vs are output to the source lines X1 to Xn in parallel. These pixel voltages Vs are supplied to the liquid crystal pixels PX of the first row, second row, third row, . . . , while each of the gate lines Y1 to Ym is driven in the first half of the associated horizontal scanning period H. In FIG. 3, a voltage-hold period PS for the gradation image is shorter than a voltage-hold period PB for the non-gradation image. Actually, the ratio of the voltage-hold period PB for the non-gradation image to the voltage-hold period PS for the gradation image is so set as to correspond to the black insertion ratio.

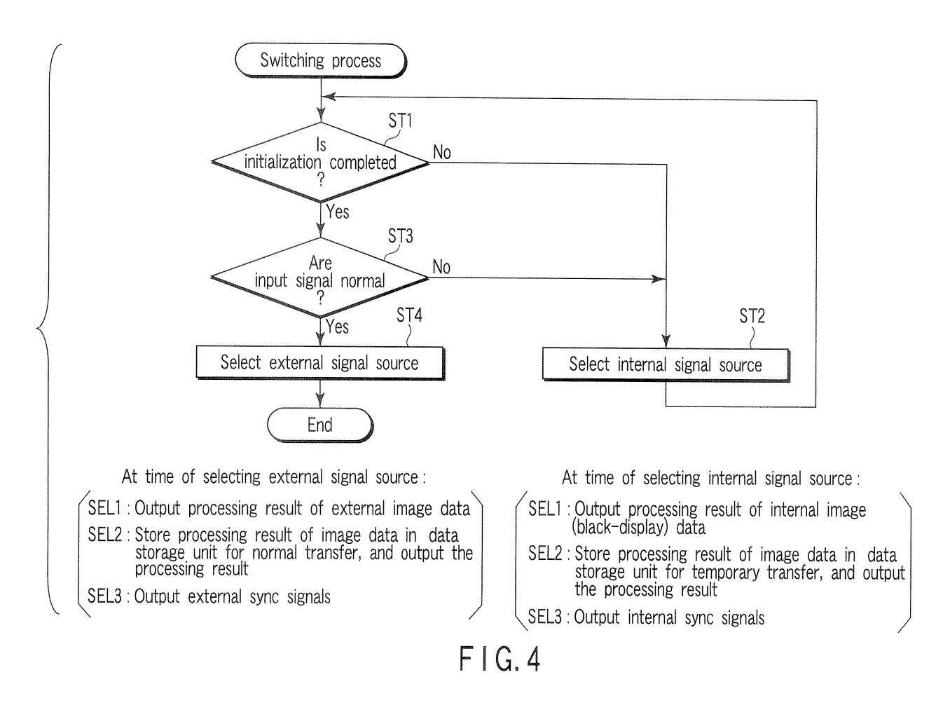

The above-described black insertion driving is executed on condition that the liquid crystal molecules are aligned in the bend alignment and that the sync signal from the external signal source SS is normal. Thus, the controller 5 includes an input signal determination unit 35 which determines whether the signals input from the external signal source SS are normal or not; an initialization determination unit 36 which determines whether the initialization for transitioning the alignment of liquid crystal molecules from the splay alignment to the bend alignment is completed; and a timing control unit 37 which outputs, upon supply of power to the system including the external signal source SS and the liquid crystal display device, the processing results of the image data and sync signals from the internal signal sources, such as the black-display data generating unit 22 and sync signal generating circuit 12, to the source driver XD and gate driver YD, and continues the output of the processing results until the determination result, which indicates the completion of the initialization, is obtained from the initialization determination unit 36, and the determination result, which indicates the normal state of the input signal, is obtained from the input signal determination unit 35. The input signal determination unit 35 is configured to determine, on the basis of the signal states of the image data, sync signal and clock signal which are supplied from the external signal source SS, that these input signals are normal. The initialization determination unit 36 is configured to detect the completion of the initialization on the basis of an elapsed time from the supply start timing of a power supply voltage Vdd that is supplied upon supply of power to the system. The timing control unit 37 selects one of the internal signal source (black-display data generating unit 22, sync signal generating circuit 12) and the external signal source SS, for example, according to a switching process flow shown in FIG. 4, and outputs switching signals SEL1 to SEL3, which correspond to the selection result, to the selection units 23, 33 and 26. In the meantime, the switching signal SEL2 is also output to the data storage unit 31 for normal transfer and the data storage unit 32 for temporary transfer.

If the switching process illustrated in FIG. 4 is started upon supply of power to the system, it is determined in step ST1 whether the determination result, which indicates the completion of the initialization of the liquid crystal molecule alignment, is obtained from the initialization determination unit 36. If the initialization of the liquid crystal molecule alignment is not completed, the internal signal source is selected in step ST2 and the process in step ST1 is executed once again. If the internal signal source is selected, the switching signal SEL1 controls the selection unit 23 so as to output the black-display data (non-gradation image pixel data) from the black-display data generating unit 22. The switching signal SEL2 controls the data storage unit 32 for temporary transfer so as to store the black-display data that is output from the selection unit 23, and also controls the selection unit 33 so as to output this black-display data. The switching signal SEL3 controls the selection unit 26 so as to output the vertical and horizontal sync signals Vsync, Hsync from the sync signal generating circuit 12. In order to perform the initialization for transitioning the alignment of liquid crystal molecules from the splay alignment to bend alignment, the timing control unit 37 controls the common voltage generating circuit 8 so as to shift, upon supply of power to the system, the common voltage Vcom to a level for providing the transition voltage.

If the completion of the initialization of the liquid crystal molecule alignment is confirmed, it is determined in step ST3 whether the determination result, which indicates the normal state of the input signal, is obtained from the input signal determination unit 35. If any of the input signals is not normal, the process in step ST2 is executed. In this case, the switching signals SEL1 to SEL3 do not vary, and the above-described control is continued. On the other hand, if it is confirmed that the input signals are normal, the external signal source SS is selected in step ST4 and the switching process is finished. If the external signal source SS is selected, the switching signal SEL1 controls the selection unit 23 so as to output the gradation image pixel data from the image data processing unit 21. The switching signal SEL2 controls the data storage unit 32 for normal transfer so as to store the gradation image pixel data that is output from the selection unit 23, and also controls the selection unit 33 so as to output the gradation image pixel data. The switching signal SEL3 controls the selection unit 26 so as to output the vertical and horizontal sync signals Vsync, Hsync (or composite sync signal ENAB) from the external signal source SS. After this switching process, the timing control unit 37 performs an operation of cyclically varying the switching signals SELL and SEL2 on the basis of the horizontal scanning timing control signal CTX, as an output switching control for black insertion driving, which is shown in FIG. 3.

In the liquid crystal display device according to the present embodiment, the controller 5 serves as a processing circuit which processes the image data and sync signals from the external signal source SS. Immediately after supply of power, the controller 5 internally generates predetermined image data (non-gradation image pixel data) and sync signals (vertical sync signal Vsync and horizontal sync signal Hsync) instead of the image data (gradation image pixel data) and sync signals from the outside, and temporarily outputs the processing results of the predetermined image data and sync signals to a driving circuit (source driver XD and gate driver YD). In other words, immediately after supply of power, the initialization of the liquid crystal molecule alignment is not completed, or the image data and sync signals from the external signal source SS are not in the normal state. In such a situation, the external image data and sync signal are not output to the driving circuit as the processing results. Thus, a noise-like image disturbance is prevented from occurring on the display panel.

The present invention is not limited to the above-described embodiment, and various modifications may be made without departing from the spirit of the invention.

In the above-described embodiment, the timing control unit 37 refers to the determination result of the input signal determination unit 35 and the determination result of the initialization determination unit 36 in order to vary the switching signals SEL1 to SEL3. Alternatively, the timing control unit 37 may be configured to refer to only one of these determination results. Specifically, in the case where only the input signal determination unit 35 is provided in order to determine whether the input signals including the image data and sync signals are normal or not, the output of the processing results of the predetermined image data and sync signals is continued until the timing control unit 37 obtains the determination result, which indicates the normal state of the input signals, from the input signal determination unit 35. In addition, in the case where only the initialization determination unit 36 is provided in order to determine whether the initialization of the liquid crystal molecule alignment is completed or not, the output of the processing results of the predetermined image data and sync signals is continued until the timing control unit 37 obtains the determination result, which indicates the completion of the liquid crystal molecule alignment, from the initialization determination unit 36.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display panel control circuit comprising:
a processing circuit which processes external image data and sync signals which are supplied from outside; and
a driving circuit which drives a display panel on the basis of processing results from said processing circuit, said processing circuit being configured to provide predetermined internal image data and sync signals which are generated immediately after supply of power and processed instead of the external image data and sync signals, and whose processing results are temporarily output to said driving circuit.

2. The display panel control circuit according to claim 1, wherein said processing circuit includes an input signal determination unit which determines whether input signals including the image data and sync signals are normal or not, and a control unit which continues the output of the processing results of the predetermined image data and sync signals until a determination result indicating that the input signals are normal is obtained from said input signal determination unit.

3. The display panel control circuit according to claim 1, wherein said display panel is an OCB mode liquid crystal display panel in which the alignment of liquid crystal molecules is initialized, upon supply of power, such that a splay alignment is transitioned to a bend alignment, and said processing circuit includes an initialization determination unit which determines whether the initialization of the liquid crystal molecule alignment is completed, and a control unit which continues the output of the processing results of the predetermined image data and sync signals until a determination result indicating that the initialization of the liquid crystal molecule alignment is completed is obtained from said initialization determination unit.

4. The display panel control circuit according to claim 1, wherein said display panel is an OCB mode liquid crystal display panel in which the alignment of liquid crystal molecules is initialized, upon supply of power, such that a splay alignment is transitioned to a bend alignment, and said processing circuit includes an initialization determination unit which determines whether the initialization of the liquid crystal molecule alignment is completed, an input signal determination unit which determines whether input signals including the image data and sync signals are normal or not, and a control unit which continues the output of the processing results of the predetermined image data and sync signals until a determination result indicating that the initialization of the liquid crystal molecule alignment is completed is obtained from said initialization determination unit, and a determination result indicating that the input signals are normal is obtained from said input signal determination unit.

5. The display panel control circuit according to claim 2, wherein said driving circuit includes a data storage unit for normal transfer, which stores the processing result of the external image data that is output from the processing circuit, a data storage unit for temporary transfer, which stores the processing result of the predetermined image data that is output from said processing circuit, and a selection unit which is controlled by said the control unit to select one of an output from said data storage unit for normal transfer and an output from said data storage unit for temporary transfer.

6. The display panel control circuit according to claim 3, wherein said driving circuit includes a data storage unit for normal transfer, which stores the processing result of the external image data that is output from the processing circuit, a data storage unit for temporary transfer, which stores the processing result of the predetermined image data that is output from said processing circuit, and a selection unit which is controlled by said the control unit to select one of an output from said data storage unit for normal transfer and an output from said data storage unit for temporary transfer.

7. The display panel control circuit according to claim 4, wherein said driving circuit includes a data storage unit for normal transfer, which stores the processing result of the external image data that is output from the processing circuit, a data storage unit for temporary transfer, which stores the processing result of the predetermined image data that is output from said processing circuit, and a selection unit which is controlled by said the control unit to select one of an output from said data storage unit for normal transfer and an output from said data storage unit for temporary transfer.

8. The display panel control circuit according to claim 5, wherein said data storage unit for temporary transfer has channels each of which commonly store an item of pixel data which is output from said processing circuit with respect to each display pixel line, as the processing result of the predetermined image data.

9. A display panel control circuit comprising:
a display panel; and
a display panel control circuit which controls a display operation of the display panel, said display panel control circuit including a processing circuit which processes external image data and sync signals which are supplied from outside, and a driving circuit which drives said display panel on the basis of processing results from said processing circuit, said processing circuit being configured to provide predetermined internal image data and sync signals which are generated immediately after supply of power and processed instead of the external image data and sync signals, and whose processing results are temporarily output to said driving circuit.

10. The display device according to claim 9, wherein said display panel is an OCB mode liquid crystal display panel in which the alignment of liquid crystal molecules is initialized, upon supply of power, such that a splay alignment is transitioned to a bend alignment, and said predetermined image data is also used to obtain a liquid crystal driving voltage which prevents reverse transition from the bend alignment to the splay alignment, after the initialization.
